(19) United States
(12) Patent Application Publication
(10) Pub. No.: US 2024/0198793 A1
(43) Pub. Date: Jun. 20, 2024

(54) ELECTRIC-VEHICLE DRIVE UNIT SYSTEM WITH AXIAL COUPLING

(71) Applicant: Atieva, Inc., Newark, CA (US)

(72) Inventors: Markus Hose, San Ramon, CA (US); Balazs Palfai, Newark, CA (US); Peter Dore Rawlinson, Foster City, CA (US); Dimitri Bassis, Union City, CA (US)

(21) Appl. No.: 18/543,164

(22) Filed: Dec. 18, 2023

Related U.S. Application Data
(60) Provisional application No. 63/476,061, filed on Dec. 19, 2022.

(51) Int. Cl. B60K 17/04; B60K 1/00; B60K 1/02; B60K 17/02; B60K 17/16

(52) U.S. Cl. CPC B60K 17/046; B60K 1/00; B60K 1/02; B60K 17/02; B60K 17/165; B60K 2001/001

(57) ABSTRACT

A drive unit system for an axle of an electric vehicle comprises: a first drive unit comprising a first rotor inside a first stator; a first transmission for a first wheel of the axle, the first transmission having a first input shaft coupled to a first gear having a first helix angle; a second transmission for a second wheel of the axle, the second transmission having a second input shaft coupled to a second gear having a second helix angle opposite to the first helix angle; and a coupling connecting the first and second input shafts to each other.

### CROSS-REFERENCE TO RELATED APPLICATION

This application claims benefit, under 35 U.S.C. § 119, of U.S. Provisional Patent Application No. 63/476,061, filed on Dec. 19, 2022, entitled “ELECTRIC-VEHICLE DRIVE UNIT SYSTEM WITH AXIAL COUPLING”, the disclosure of which is incorporated by reference herein in its entirety.

### TECHNICAL FIELD

This document relates to electric-vehicle drive unit system with an axial coupling.

### BACKGROUND

An important performance characteristic of an electric vehicle (EV) is its range, meaning the estimated distance it can travel before recharging the battery. To maximize the range, manufacturers seek to eliminate energy losses in the vehicle. In EV powertrains, one area where losses occur is in transmission bearings.

Like other vehicles, EVs can improve the driving experience by providing cross-axle torque management, meaning that more power is sometimes distributed to one of the wheels than the other when the wheels have different amounts of traction. In EVs with more than one motor per axle, such torque control has been implemented by way of motor control algorithms. However, these approaches may make a vehicle feel somewhat less stable to the driver and may have disadvantages in offroad driving.

### SUMMARY

In a first aspect, a drive unit system for an axle of an electric vehicle comprises: a first drive unit comprising a first rotor inside a first stator; a first transmission for a first wheel of the axle, the first transmission having a first input shaft coupled to a first gear having a first helix angle; a second transmission for a second wheel of the axle, the second transmission having a second input shaft coupled to a second gear having a second helix angle opposite to the first helix angle; and a coupling connecting the first and second input shafts to each other.

Implementations can include any or all of the following features. The first drive unit is a single drive unit for the drive unit system, the single drive unit having an active core in a hollow rotor shaft of the first rotor, and wherein the single drive unit drives the first and second input shafts using the active core. The coupling provides torque control between the first and second input shafts. The coupling comprises a clutch pack coupled to the first and second input shafts. The coupling comprises a friction pack coupled to the first and second input shafts. The coupling comprises a locking device coupled to the first and second input shafts. The coupling provides load cancelation between the first and second transmissions. The coupling comprises a thrust bearing coupled to the first and second input shafts. The coupling comprises thrust washers coupled to the first and second input shafts, respectively. The drive unit system further comprises a second drive unit comprising a second rotor inside a second stator, the first and second drive units being a twin drive unit for the drive unit system, wherein the first drive unit drives the first input shaft, and wherein the second drive unit drives the second input shaft. The coupling provides torque control between the first and second input shafts. The coupling comprises a clutch pack coupled to the first and second input shafts. The coupling comprises a friction pack coupled to the first and second input shafts. The coupling comprises a locking device coupled to the first and second input shafts. The coupling comprises a limited slip differential coupled to the first and second input shafts. The coupling provides load cancelation between the first and second transmissions. The coupling comprises a thrust bearing coupled to the first and second input shafts. The coupling comprises thrust washers coupled to the first and second input shafts, respectively.

In a second aspect, a twin drive unit system for an axle of an electric vehicle comprises: a first drive unit comprising a first rotor inside a first stator; a second drive unit comprising a second rotor inside a second stator; a first transmission for a first wheel of the axle, the first transmission having a first input shaft, wherein the first drive unit drives the first input shaft; a second transmission for a second wheel of the axle, the second transmission having a second input shaft, wherein the second drive unit drives the second input shaft; and a coupling connecting the first and second input shafts to each other.

Implementations can include any or all of the following features. The coupling comprises a clutch pack coupled to the first and second input shafts. The coupling comprises a friction pack coupled to the first and second input shafts. The coupling comprises a limited slip differential coupled to the first and second input shafts. The coupling comprises a thrust bearing coupled to the first and second input shafts. The coupling comprises thrust washers coupled to the first and second input shafts, respectively.

### BRIEF DESCRIPTION OF DRAWINGS

FIG. 1 shows an example of a wheel axle system.

FIG. 2 shows a cross section of an example of a twin drive unit system.

FIG. 3 shows an example of a friction pack.

FIG. 4 shows an example of a clutch pack.

FIG. 5 shows an example of a limited slip differential.

FIG. 6 shows an example of a locking device.

FIG. 7 shows a cross section of an example of a single drive unit system.

Like reference symbols in the various drawings indicate like elements.

### DETAILED DESCRIPTION

This document describes examples of systems and techniques for providing an EV drive unit system with an axial coupling. For example, the axial coupling can improve drive unit efficiency. In some implementations, cross-axle torque control can be provided, for example as a complement to torque vectoring motor control algorithms. In some implementations, a twin motor arrangement has two independent transmission systems each delivering a power path to its respective output. The transmission systems can have helical gears to provide improved noise, vibration and handling (NVH) characteristics, wherein the gears have opposing helical angles to each other. Connecting two transmission input gears (sun gears) can provide at least one of the following advantages. First, axial forces of the sun gears can be canceled, resulting in a substantial reduction of losses. Particularly, the input shaft is generally the fastest traveling component of the drivetrain, so any improvement at the input shaft is a powerful way of reducing losses. Second, the coupling can allow a straightforward implementation of cross-axle torque control, such as in form of a limited slip differential.

In some implementations, each of the inputs to the transmissions have opposing helical angles and the input between the two transmission input shafts is connected so that each power path is independent in torque and speed. Moreover, the axial connection can provide that the axial loads cancel each other out in the dominant torque transfer direction (e.g., driving forward). As such, an implementation can take advantage of the axial loads caused by the helix angles.

In some implementations, the two input shafts of a twin drive unit or of a single drive unit can be connected by a bearing that has a surface of an acting member attached to each input shaft. In the condition where both input shafts are rotating at the same speed there is no speed across the bearing. Moreover, when the transmission systems are at different speeds (e.g., when the vehicle is cornering) the bearing is only subject to the relative speed difference between the inputs.

Examples described herein refer to a vehicle. A vehicle is a machine that transports passengers or cargo, or both. A vehicle can have one or more electric motors. Examples of vehicles include, but are not limited to, cars, trucks, buses, motorcycles, and scooters. The number of wheels can differ between types of vehicles, and one or more (e.g., all) of the wheels can be used for propulsion of the vehicle. The vehicle can include a passenger compartment accommodating one or more persons. A vehicle can be powered exclusively by electricity, or can use one or more other energy source in addition to electricity. One or more of the vehicle's axles can be powered.

Examples described herein refer to an electric motor. A vehicle can have one or two electric motors powering an axle of the vehicle. An electric motor as used herein can be any type of electric motor, including, but not limited to, a permanent-magnet motor, an induction motor, a synchronous motor, or a reluctance motor.

Examples described herein refer to a top, bottom, front, side, or rear. These and similar expressions identify things or aspects in a relative way based on an express or arbitrary notion of perspective. That is, these terms are illustrative only, used for purposes of explanation, and do not necessarily indicate the only possible position, direction, and so on.

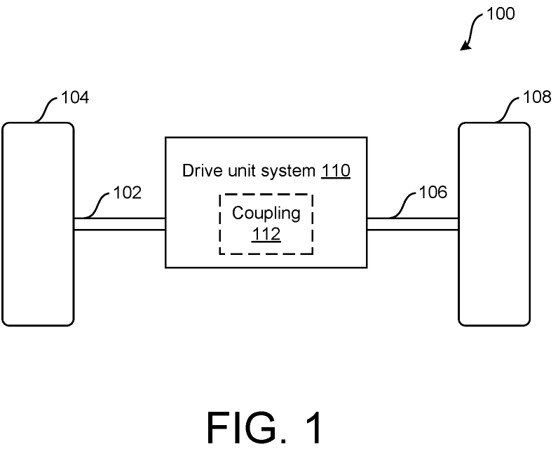

FIG. 1 shows an example of a wheel axle system 100. The wheel axle system 100 can be used with one or more other examples described elsewhere herein. The wheel axle system 100 has an axle 102 to a wheel 104, and an axle 106 to a wheel 108. The wheel axle system 100 has a drive unit system 110 that is a twin drive unit (a separate drive unit for each of the axles 102 and 106) or a single drive unit (one drive unit for both of the axles 102 and 106). The drive unit system 110 powers the wheel 104 using one transmission, and powers the wheel 108 using another transmission. The drive unit system 110 has a coupling 112 between the respective input shafts of the transmissions. For example, the coupling 112 can cancel axial loads of the transmissions and thereby reduce losses. As another example, the coupling 112 can provide cross-axle torque management in the wheel axle system 100.

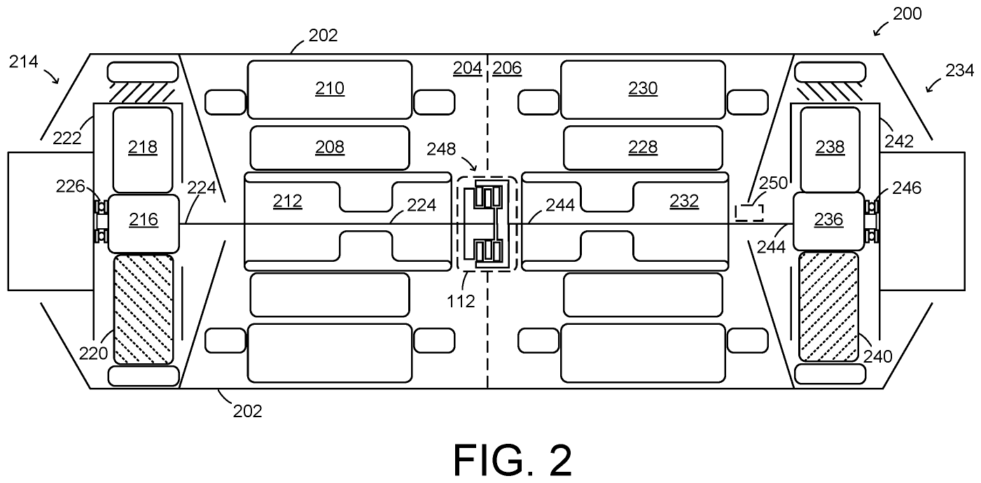

FIG. 2 shows a cross section of an example of a twin drive unit system 200. The twin drive unit system 200 can be used with one or more other examples described elsewhere herein. For example, the twin drive unit system 200 can be the drive unit system 110 in FIG. 1. The twin drive unit system 200 is here schematically shown and some components are omitted for clarity, including, but not limited to, power electronics, thermal control system, and motor control circuitry. The twin drive unit system 200 is essentially contained in a housing 202. For example, the housing 202 can cover the components of the twin drive unit system 200 except at each end where the wheel axles extend toward the respective wheels.

The twin drive unit system 200 includes a drive unit 204 and a drive unit 206. The drive unit 204 includes a rotor 208 inside a stator 210. For example, the rotor 208 is formed by laminations stacked on a rotor shaft 212 and optionally includes permanent magnets. The stator 210 can include windings extending through slots. The drive unit 204 includes a transmission 214 with a sun gear 216, and at least planetary gears 218 and 220, held by a housing 222. The transmission 214 can have helical gears or straight-cut gears. For example, while the planetary gear 220 is here shown in cross section, dashed lines are used to schematically illustrate the helical angle that can be used (e.g., for NVH management). The drive unit 204 has an input shaft 224 to the transmission 214, here schematically shown as a line extending from the sun gear 216 through the center of the rotor shaft 212. At the outer end of the input shaft 224, a bearing 226 can be positioned between the sun gear 216 and the housing 222.

Similarly, the drive unit 206 includes a rotor 228 inside a stator 230. For example, the rotor 228 is formed by laminations stacked on a rotor shaft 232 and optionally includes permanent magnets. The stator 230 can include windings extending through slots. The drive unit 206 includes a transmission 234 with a sun gear 236, and at least planetary gears 238 and 240, held by a housing 242. The transmission 234 can have helical gears or straight-cut gears. For example, while the planetary gear 240 is here shown in cross section, dashed lines are used to schematically illustrate the helical angle that can be used (e.g., for NVH management). The helical angle of the transmission 234 can be opposite to the helical angle of the transmission 214. The drive unit 206 has an input shaft 244 to the transmission 234, here schematically shown as a line extending from the sun gear 236 through the center of the rotor shaft 232. At the outer end of the input shaft 244, a bearing 246 can be positioned between the sun gear 236 and the housing 242.

When the transmissions 214 and 234 have helical gear angles, their operation creates an axial load in the respective input shafts 224 and 244. When the vehicle is being accelerated, positive torque is generated and a load (e.g., a torque-dependent thrust) is applied to each of the input shafts 224 and 244 in a direction toward a center of the twin drive unit system 200. When the vehicle is being decelerated using regenerative braking, negative torque is generated and a load is instead applied to each of the input shafts 224 and 244 in a direction away from a center of the twin drive unit system 200. For example, such load can be reacted using the bearings 226 and 246.

In the twin drive unit system 200, a thrust bearing 248 corresponds to the coupling 112 in FIG. 1. One side of the thrust bearing 248 is coupled to the input shaft 224, and another side of the thrust bearing 248 is coupled to the input shaft 244. The thrust bearing 248 can provide at least the advantage of canceling the axial loads in the input shafts 224 and 244.

If the twin drive unit system 200 did not have the thrust bearing 248 (or another instance of the coupling 112), one or more additional bearings would have been installed to react the load. For example, at a location 250 in the twin drive unit system 200 a bearing could have been placed between the input shaft 244 and a portion of the housing 202, with a corresponding bearing used for the input shaft 224. However, reacting loads through bearings is associated with energy loss. Particularly, the loss in a bearing can be proportional to the product of the bearing's rotational speed and the load on the bearing. It was mentioned above that the input shafts 224 and 244 may be the fastest rotating components in the vehicle, and a bearing at the location 250 where it has one side grounded against the housing 202 would then assume a considerable rotational speed. As a result, if substantial load were reacted through a bearing at the location 250, that bearing would be subject to significant losses.

Here, however, the twin drive unit system 200 has the thrust bearing 248 (or another instance of the coupling 112) that cancels the axial loads. When the vehicle is driving in a straight direction (i.e., is not currently cornering), which may be the case in many driving situations, the speeds of the input shafts 224 and 244 can be substantially identical. That is, a motor controller of the twin drive unit system 200 may in such a situation be requesting the same amount of torque from each of the drive units 204 and 206, but due to some largely unavoidable system variations the rotational speeds of the input shafts 224 and 244 may be slightly different from each other. For example, such variations can be due to tire manufacturing variations and/or minor differences in rolling radius. That is, while each side of the thrust bearing 248 may be rotating at a considerable speed in such situation, the relative speed between the two sides may be zero or substantially zero. Even during cornering, the relative speed difference between the input shafts 224 and 244 may be relatively small compared to the absolute speed of either of them. Because the bearing speed is one of the factors influencing the loss, it follows that the loss can be significantly reduced by bringing the relative speed close to zero. Moreover, due to load canceling there may be zero or next to zero net load that needs to be reacted in the center of the twin drive unit system 200. As such, the thrust bearing 248 can be a very efficient bearing arrangement. In the present arrangement, even if a bearing were also to be placed at the location 250, that bearing would not need to react any axial load of the input shaft, and so the bearing would be very efficient.

In some implementations, the coupling 112 in FIG. 1 can provide cross-axle torque control. This can improve the driving characteristics of the vehicle and give better performance also in challenging situations when wheels have different traction, such as in slippery road conditions or during offroad driving. Some examples are provided in the following.

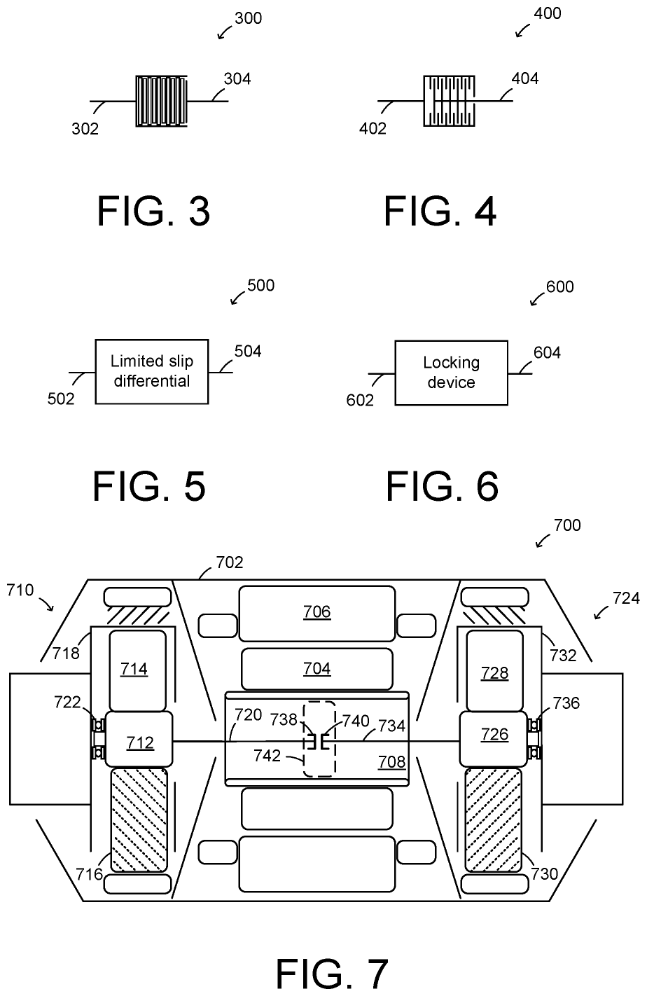

FIG. 3 shows an example of a friction pack 300. The friction pack 300 can be used with one or more other examples described elsewhere herein. The friction pack 300 can be connected to input shafts 302 and 304, and can include two or more friction plates arranged to move relative to each other when there is relative rotation between the input shafts 302 and 304. In some implementations, the friction pack can provide a preload to the cross-axle torque control. For example, such preload can effectively create a hysteresis for a torque controller to work against, which can improve the performance of the controller's error correction function.

FIG. 4 shows an example of a clutch pack 400. The clutch pack 400 can be used with one or more other examples described elsewhere herein. The clutch pack 400 can be connected to input shafts 402 and 404, and can include any kind of clutch pack arrangement including, but not limited to, a dog clutch, a viscose coupling, or an actively controlled clutch pack. For example, the clutch pack 400 includes discs squeezed by pressure to lock the clutch pack components together and control torque across the input shafts 402 and 404.

FIG. 5 shows an example of a limited slip differential (LSD) 500. The LSD 500 can be used with one or more other examples described elsewhere herein. The LSD 500 can be connected to input shafts 502 and 504, and can use any of multiple approaches for limiting the slip that might otherwise occur between the wheels of an axle, including but not limited to, a viscous and clutch-based LSD, a spring-loaded geared LSD, a clutch- and plate-based LSD based on resistance, an LSD based on viscous coupling by silicone fluid, or an actively controlled LSD based on controlled clutch devices.

FIG. 6 shows an example of a locking device 600. The locking device 600 can be used with one or more other examples described elsewhere herein. The locking device 600 can be connected to input shafts 602 and 604, and can include a torque dependent mechanical locking mechanism that provides cross-axle torque management. For example, the locking device 600 uses friction to manage torque.

FIG. 7 shows a cross section of an example of a single drive unit system 700. The single drive unit system 700 can be used with one or more other examples described elsewhere herein. For example, the single drive unit system 700 can be the drive unit system 110 in FIG. 1. The single drive unit system 700 is here schematically shown and some components are omitted for clarity including, but not limited to, power electronics, thermal control system, and motor control circuitry. The single drive unit system 700 is essentially contained in a housing 702. For example, the housing 702 can cover the components of the single drive unit system 700 except at each end where the wheel axles extend toward the respective wheels.

The single drive unit system 700 includes a rotor 704 inside a stator 706. For example, the rotor 704 is formed by laminations stacked on a rotor shaft 708 and optionally includes permanent magnets. The stator 706 can include windings extending through slots. The single drive unit system 700 includes a transmission 710 with a sun gear 712, and at least planetary gears 714 and 716, held by a housing 718. The transmission 710 can have helical gears or straight-cut gears. For example, while the planetary gear 716 is here shown in cross section, dashed lines are used to schematically illustrate the helical angle that can be used (e.g., for NVH management). The single drive unit system 700 has an input shaft 720 to the transmission 710, here schematically shown as a line extending from the sun gear 712 through the center of the rotor shaft 708. At the outer end of the input shaft 720, a bearing 722 can be positioned between the sun gear 712 and the housing 718. The single drive unit system 700 includes a transmission 724 with a sun gear 726, and at least planetary gears 728 and 730, held by a housing 732. The transmission 724 can have helical gears or straight-cut gears. For example, while the planetary gear 730 is here shown in cross section, dashed lines are used to schematically illustrate the helical angle that can be used (e.g., for NVH management). The helical angle of the transmission 724 can be opposite to the helical angle of the transmission 710. The single drive unit system 700 has an input shaft 734 to the transmission 724, here schematically shown as a line extending from the sun gear 726 through the center of the rotor shaft 708. At the outer end of the input shaft 734, a bearing 736 can be positioned between the sun gear 726 and the housing 732.

When the transmissions 710 and 724 have helical gear angles, their operation creates an axial load in the respective input shafts 720 and 734. When the vehicle is being accelerated, positive torque is generated and a load (e.g., a torque-dependent thrust) is applied to each of the input shafts 720 and 734 in a direction toward a center of the single drive unit system 700. When the vehicle is being decelerated using regenerative braking, negative torque is generated and a load is instead applied to each of the input shafts 720 and 734 in a direction away from a center of the single drive unit system 700. For example, such load can be reacted using the bearings 722 and 736.

In the single drive unit system 700, a thrust washer arrangement corresponds to the coupling 112 in FIG. 1. A thrust washer 738 can be coupled to the inner end of the input shaft 720, and a thrust washer 740 can be coupled to the inner end of the input shaft 734. The thrust washer arrangement can provide at least the advantage of canceling the axial loads in the input shafts 720 and 734. The single drive unit system 700 has an active core differential 742 in the rotor shaft 708. In some implementations, the active core differential 742 can include one or more hollow cross members, gears, and pins mounted in a hollow interior of the rotor shaft 708. As such, the thrust washers 738-740 connect and cancel each other's loads, with no relative speed between them unless the vehicle is cornering.

Referring now again to the twin drive unit system 200 in FIG. 2, implementation of the coupling 112 can provide an advantageous benefit when applying torque vectoring to the outputs of the drive units 204 and 206. Torque vectoring is a form of motor control algorithm where the motor controller may request more of the torque from the drive unit powering a wheel that currently has more traction. Torque vectoring is implemented by the motor controller using a feed forward signal (i.e., torque) and an error feedback loop, where the error is the difference in torque between the two drive units. When the error signal is large, torque vectoring works relatively well. For example, this is the case during aggressive driving like track work or drifting, or in offroad driving conditions, where there may be significant differences in torque and speed between the traction wheels,

However, when the vehicle is driving straight forward, the motor controller requests the same amount of torque from both drive units, so the error signal should in principle be zero. Moreover, due to reasons exemplified above, small variations may occur that cause the error signal to have a very small nonzero value in the above situation despite the request for equal amounts of torque. Because the error signal is very small, the motor controller cannot use it for controlling the torque and will instead rely on the feed forward signal. This situation for the motor controller can manifest itself in minor or subtle instability during driving, sometimes leading the driver to experience the vehicle as not being properly centered, or not feeling “planted” on the roadway.

Implementations of the present subject matter can provide some amount of friction between the respective drive shafts of a twin drive unit. This can help the motor controller get a better error signal in the feedback loop, and thereby make the controller better at a task it may otherwise struggle with: getting to and maintaining a zero speed difference condition. The friction can provide a good stability overlay on top of the dynamic motor controller. This can create hysteresis for the controller so that when the controller is to enact torque vectoring, the controller must overcome the friction between the input shafts as well.

Another example where a motor controller implementing torque vectoring may suffer from performance problems is in offroad driving involving a very loose traction surface, such as wet grass. When the wheel begins to spin because it loses traction on the grass, this gives the controller an error signal to work with. However, the amount of wheel spin that occurs before the torque vectoring is effectuated may likely damage the underlying surface, thereby changing the condition that the requested torque vectoring was supposed to address. The present subject matter can provide a passive system, such as a locking device or another torque control mechanism, that substantially reduces the amount of wheel spin in the above situation. That is, as soon as one of the wheels encounters a lower friction coefficient, sometimes referred to by the Greek letter μ (mu), torque is instead provided to the other wheel, thereby substantially reducing or eliminating any wheel spin. Because the underlying surface remains undestroyed in this example, the torque vectoring is substantially more successful at managing the torque.

Moreover, the present subject matter can allow drive unit systems to be designed without the deliberate oversizing of components that have sometimes been made in previous approaches. Some offroad applications involve the situation where one wheel has substantially more traction than the other, yet the powertrain must nevertheless be able to move the vehicle. For these and similar situations, previous drive units have sometimes been designed with an amount of oversizing to provide sufficient torque to drive the vehicle. In the present subject matter, the torque can get an axial component that goes through a torque control device such as a friction pack. As a result, the motor for the low-friction wheel can overdrive more than the low-friction wheel can deliver, because that torque can go to the high-friction side. So the motor of the high-friction wheel can go to its sustained torque level and be supplemented by the motor on the low-friction side. As such, there is no need to overdesign the inverters or motors, which would lead to the greatest increase of expense in terms of extra mass, volume, and losses.

The terms “substantially” and “about” used throughout this Specification are used to describe and account for small fluctuations, such as due to variations in processing. For example, they can refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A drive unit system for an axle of an electric vehicle, the drive unit system comprising:
a first drive unit comprising a first rotor inside a first stator;
a first transmission for a first wheel of the axle, the first transmission having a first input shaft coupled to a first gear having a first helix angle;
a second transmission for a second wheel of the axle, the second transmission having a second input shaft coupled to a second gear having a second helix angle opposite to the first helix angle; and
a coupling connecting the first and second input shafts to each other.

2. The drive unit system of claim 1, wherein the first drive unit is a single drive unit for the drive unit system, the single drive unit having an active core in a hollow rotor shaft of the first rotor, and wherein the single drive unit drives the first and second input shafts using the active core.

3. The drive unit system of claim 2, wherein the coupling provides torque control between the first and second input shafts.

4. The drive unit system of claim 3, wherein the coupling comprises a clutch pack coupled to the first and second input shafts.

5. The drive unit system of claim 3, wherein the coupling comprises a friction pack coupled to the first and second input shafts.

6. The drive unit system of claim 3, wherein the coupling comprises a locking device coupled to the first and second input shafts.

7. The drive unit system of claim 1, wherein the coupling provides load cancelation between the first and second transmissions.

8. The drive unit system of claim 7, wherein the coupling comprises a thrust bearing coupled to the first and second input shafts.

9. The drive unit system of claim 7, wherein the coupling comprises thrust washers coupled to the first and second input shafts, respectively.

10. The drive unit system of claim 1, further comprising a second drive unit comprising a second rotor inside a second stator, the first and second drive units being a twin drive unit for the drive unit system, wherein the first drive unit drives the first input shaft, and wherein the second drive unit drives the second input shaft.

11. The drive unit system of claim 10, wherein the coupling provides torque control between the first and second input shafts.

12. The drive unit system of claim 11, wherein the coupling comprises a clutch pack coupled to the first and second input shafts.

13. The drive unit system of claim 11, wherein the coupling comprises a friction pack coupled to the first and second input shafts.

14. The drive unit system of claim 11, wherein the coupling comprises a locking device coupled to the first and second input shafts.

15. The drive unit system of claim 11, wherein the coupling comprises a limited slip differential coupled to the first and second input shafts.

16. The drive unit system of claim 10, wherein the coupling provides load cancelation between the first and second transmissions.

17. The drive unit system of claim 16, wherein the coupling comprises a thrust bearing coupled to the first and second input shafts.

18. The drive unit system of claim 16, wherein the coupling comprises thrust washers coupled to the first and second input shafts, respectively.

19. A twin drive unit system for an axle of an electric vehicle, the twin drive unit system comprising:
a first drive unit comprising a first rotor inside a first stator;
a second drive unit comprising a second rotor inside a second stator;
a first transmission for a first wheel of the axle, the first transmission having a first input shaft, wherein the first drive unit drives the first input shaft;
a second transmission for a second wheel of the axle, the second transmission having a second input shaft, wherein the second drive unit drives the second input shaft; and
a coupling connecting the first and second input shafts to each other.

20. The twin drive unit system of claim 19, wherein the coupling comprises a clutch pack coupled to the first and second input shafts.

21. The twin drive unit system of claim 19, wherein the coupling comprises a friction pack coupled to the first and second input shafts.

22. The twin drive unit system of claim 19, wherein the coupling comprises a limited slip differential coupled to the first and second input shafts.

23. The twin drive unit system of claim 19, wherein the coupling comprises a thrust bearing coupled to the first and second input shafts.

24. The twin drive unit system of claim 19, wherein the coupling comprises thrust washers coupled to the first and second input shafts, respectively.
